(19) United States
(12) Patent Application Publication
(10) Pub. No.: US 2022/0353193 A1
(43) Pub. Date: Nov. 3, 2022

(54) TRANSMISSION RATE MODIFICATION BASED ON PREDICTED DATA

(71) Applicant: Hewlett-Packard Development Company, L.P., Spring, TX (US)

(72) Inventors: Amalendu Iyer, Palo Alto, CA (US); Christian Makaya, Palo Alto, CA (US); Jonathan Munir Salfity, Palo Alto, CA (US)

(73) Assignee: Hewlett-Packard Development Company, L.P., Spring, TX (US)

(21) Appl. No.: 17/765,877

(22) PCT Filed: Oct. 18, 2019
(86) PCT No.: PCT/US2019/057018

§ 371 Date: Apr. 1, 2022

(51) Int. Cl. H04L 47/263; H04W 28/10

(52) U.S. Cl. CPC H04L 47/263; H04W 28/10

(57) ABSTRACT

According to examples, an apparatus may include a processor and a non-transitory computer readable medium on which is stored instructions that the processor may execute to determine whether to modify a transmission rate at which time series data is transmitted to a remote computer. The determination is based on a prediction of the time series data.

### BACKGROUND

There are many applications where data is transmitted from a device to a server for further processing. For example, for Internet of Things (IoT), the number of devices that capture sensory information like images, audio, three-dimensional point-cloud, environmental data, etc. has increased dramatically over the past few years and it is predicted that the deployment of such devices will continue to increase. In many instances, devices, such as sensors that capture sensory data about their environment for IoT applications or other types of devices, periodically or continuously transmit data over a network to a remote computer for further processing.

### BRIEF DESCRIPTION OF DRAWINGS

Features of the present disclosure are illustrated by way of example and not limited in the following figure(s), in which like numerals indicate like elements, in which:

FIG. 1 shows a computing device that may determine a transmission rate modification based on predicted data, according to an example;

FIG. 2 shows a data flow diagram for transmission rate modification, according to an example;

FIG. 3 shows a computing device that may determine a transmission rate modification based on encoding and predicted data, according to an example;

FIG. 4 shows a data flow diagram for transmission rate modification, according to another example;

FIG. 5 shows a system diagram, according to an example; and

FIG. 6 shows a method, according to an example.

### DETAILED DESCRIPTION

For simplicity and illustrative purposes, the principles of the present disclosure are described by referring mainly to examples thereof. In the following description, numerous specific details are set forth in order to provide an understanding of the examples. It will be apparent, however, to one of ordinary skill in the art, that the examples may be practiced without limitation to these specific details. In some instances, well known methods and/or structures have not been described in detail so as not to unnecessarily obscure the description of the examples. Furthermore, the examples may be used together in various combinations.

Throughout the present disclosure, the terms “a” and “an” are intended to denote one of a particular element or multiple ones of the particular element. As used herein, the term “includes” means includes but not limited to, the term “including” means including but not limited to. The term “based on” may mean based in part on.

When a large number of devices stream data to a remote computer over a network, such as in an IoT environment or other environments, it can lead to high bandwidth consumption and network congestion. Consequently, this can lead to a reduction in quality of service for all the devices connected to the network or for applications that rely on receiving the data in a timely manner. For example, in many instances, these devices stream data to a remote server for further processing. Applications may rely on the processed data for performing their functions. If there is a delay in streaming the data, which may be caused by network congestion, then the performance of the applications relying on the received data can degrade, especially for real-time applications.

Disclosed according to examples herein are apparatuses, systems, and methods for automatically controlling transmission rate from a device to a remote computer over a network based on a prediction of data being transmitted by the device. For example, a device may stream data to a remote computer. The data may be sensor data captured by a sensor of the device. A prediction is made as to a current value of the sensor data and then the prediction is compared to an actual current value measured by the sensor. If the predicted current value and the actual current value are similar, then the transmission rate may be reduced because it is assumed the transmitted data is not changing beyond what is expected. A machine learning predictor may be used to predict the sensor data. Also, a machine learning encoder may be used to encode data to a lower dimensional space prior to making predictions on the sensor data. Additionally, a comparison function that helps minimize false positives may be used to compare the predicted current sensor data with the actual current sensor data to determine whether the predicted and actual current sensor data are different for making transmission rate modification decisions. Through implementation of the apparatuses, systems, and methods disclosed herein, transmission may be automatically adjusted rate to alleviate potential network congestion, and thus improve quality of service for applications relying on the data transmitted from the device.

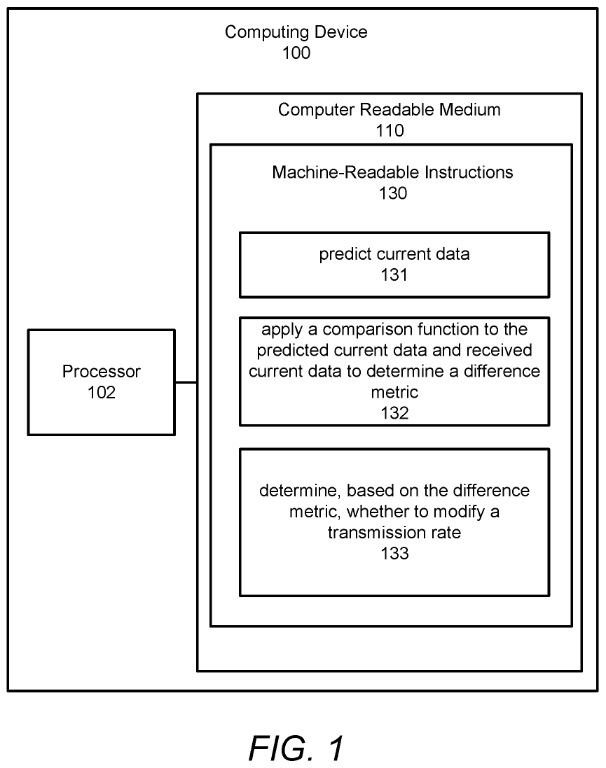

FIG. 1 shows an example of a computing device or other electronic device that may facilitate automatic adjustment of transmission rate of data based on predictions of the data to be transmitted. The computing device 100 may include a processor 102. The processor 102 may be a semiconductor-based microprocessor, a central processing unit (CPU), a graphics processing unit (GPU), an application specific integrated circuit (ASIC), a field-programmable gate array (FPGA), and/or other hardware devices that can perform the operations of the processor 102. The computing device 100 may also include a non-transitory computer readable medium 110 that may have stored thereon machine-readable instructions 130 (which may also be termed computer readable instructions) that the processor 102 can execute. The non-transitory computer readable medium 110 may be an electronic, magnetic, optical, or other physical storage device that includes or stores executable instructions. The non-transitory computer readable medium 110 may be, for example, Random Access memory (RAM), an Electrically Erasable Programmable Read-Only Memory (EEPROM), a storage device, an optical disc, and the like. The term “non-transitory” does not encompass transitory propagating signals.

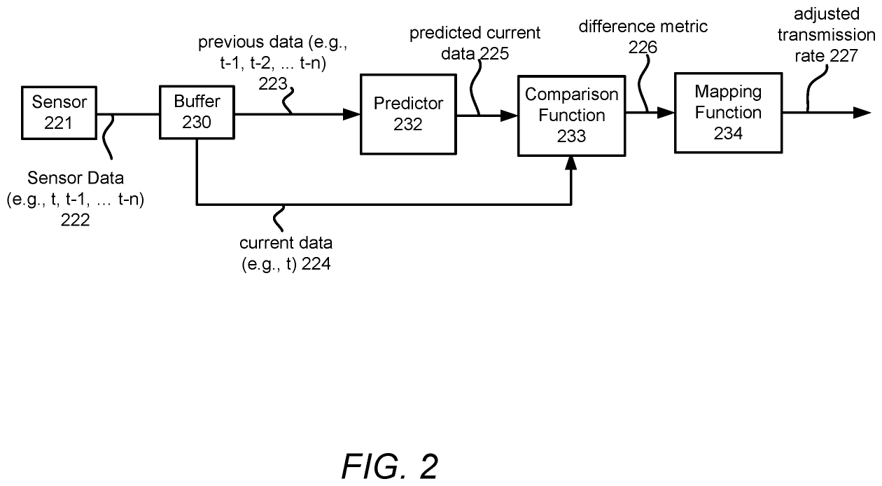

The machine-readable instructions 130 are described with respect to a flow diagram shown in FIG. 2. The machine-readable instructions 130 executable by the processor 102 include instructions 131 to predict current data from received data. In an example, the received data is time series data comprised of data points captured over time. For example, as shown in FIG. 2, a sensor 221 may capture sensor data 222 continually or periodically. In an example, the sensor is a camera, and the camera is capturing images of an environment for transmission to a remote computer for further processing. Each image is associated with a time that the image is captured. For example, the current image, i.e., the most recently captured image, is associated with a time t, and previously captured images are associated with times t-1, t-2 . . . t-n, where n is an integer. A buffer 230 or another type of data storage may store the sensor data 222.

The processor 102 executes the instructions 131 to predict current data, shown as predicted current data 225 in FIG. 2. For example, previous data 223, which may be extracted from the buffer 230, may include previously captured images associated with times t-1, t-2, . . . t-n. The previous data 223 is input to predictor 232 to determine the predicted current data 225 for time t. The predicted current data 225 is a prediction of current data 224, which is the sensor data for time t. For example, the current data 224 is the current image captured by the sensor 221 for time t, and the predicted current data 225 is a prediction of the current image or a portion of the current image captured for time t, which is determined based on the previous images captured for earlier times.

The predictor 232, for example, is a machine learning predictor. For example, a neural network may be trained to make the predictions for sensor data comprised of images or audio. Different machine learning functions may be used for making predictions for different types of data. In an example, the predictor 232 may be a deep learning model employing a deep neural network (DNN), such as convolutional neural network (CNN), long short-term memory (LSTM) in cascade with a fully-connected neural network (FCNN), or the like. The predictor 232 may be trained with a collection of annotated datasets that are used for supervised-learning tasks and based on the previous data 223. In an example, the predictor 232 is trained to identify people and/or objects in an image, and based on the previous data 223. The predictor 232 may predict that an identified object should be located in a particular location in a current image. If the object is determined to be at that location in the actual current image, then the predicted current image and the actual current image may be considered to be the same or similar.

Instructions 132 shown in FIG. 1 are executed by the processor 102 to apply a comparison function to the predicted current data and the received current data (e.g., actual current data captured by the sensor 221) to determine a difference metric. For example, referring to FIG. 2, predicted current data 225 and current data 224 are applied to comparison function 233 to determine a difference metric 226 that represents a difference between the predicted current data 225 and current data 224.

In an example, the comparison function 233 is a cosine similarity function. Cosine similarity is a metric used to determine how similar vectors are irrespective of their size. Mathematically, it measures the cosine of the angle between two vectors projected in a multi-dimensional space. In an example, pixels in the captured current image and the predicted current image are values in respective vectors, and the vectors are compared using cosine similarity. If the vectors are the same, the difference metric 226 (e.g., cosine similarity metric) is 1.0, and the difference metric 226 is 0 if they are orthogonal; otherwise the difference metric 226 is between 0 and 1 depending on how similar or different the vectors are. It will be apparent to one of ordinary skill in the art that other types of comparison functions may be used to compare the predicted current data 225 and current data 224.

Instructions 133 are executed by the processor 102 to determine, based on the difference metric 226, whether to modify a transmission rate at which the data, such as the sensor data 222, is transmitted to a remote computer. For example, the sensor 221 may stream the sensor data 222 to a remote computer for further processing. Also, multiple sensors may stream sensor data to the remote computer over the same network. If the predicted current data 225 and current data 224 are determined to be the same or similar, then the transmission rate for transmitting the sensor data 222 captured by the sensor 221 may be reduced to alleviate network congestion. Generally, if the predictor 232 is able to predict the current data 224, e.g., the predicted current data 225 and the current data 224 are the same or similar, then it is assumed that the current data 224 is what is expected and the transmission rate may be reduced. If the predicted current data 225 and the current data 224 are different, then the transmission rate may be increased. For example, if the sensor 221 is a security camera streaming images or video of an entrance to a home, the captured images may be the same or quite similar if no one is approaching the entrance to the home. Thus, there may not be a need to receive the images as frequently or as quickly. However, if the captured image includes a person approaching the entrance to the home, then the captured image including the person is different than the predicted image not including a person. Then, the transmission rate may be increased to receive images or video more frequently or quickly in order to identify the person approaching the entrance to the home as quickly as possible and provide proper notifications as quickly as possible.

Similar operations may be performed for other sensors transmitting data to the remote computer. In the example shown in FIG. 2, the difference metric 226 is fed to mapping function 234 to determine whether to adjust the transmission rate 227. In an example, the mapping function 234 maps the difference metric to a value between a minimum and a maximum transmission rate that is supported by the device transmitting the sensor data 222 to the remote computer over the network. For example, each possible value of the difference metric 226 is mapped to particular transmission rate. In an example, different ranges of the difference metric 226 are mapped to different transmission rates.

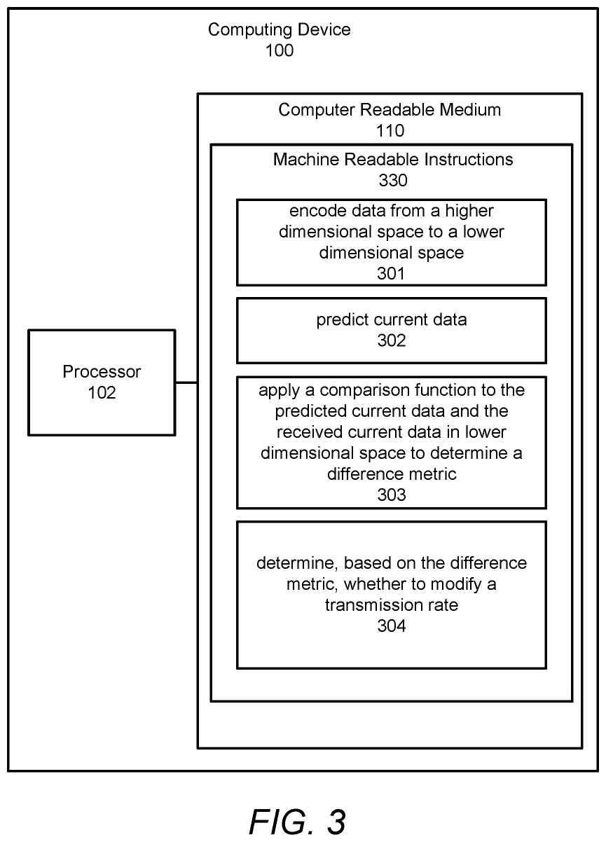

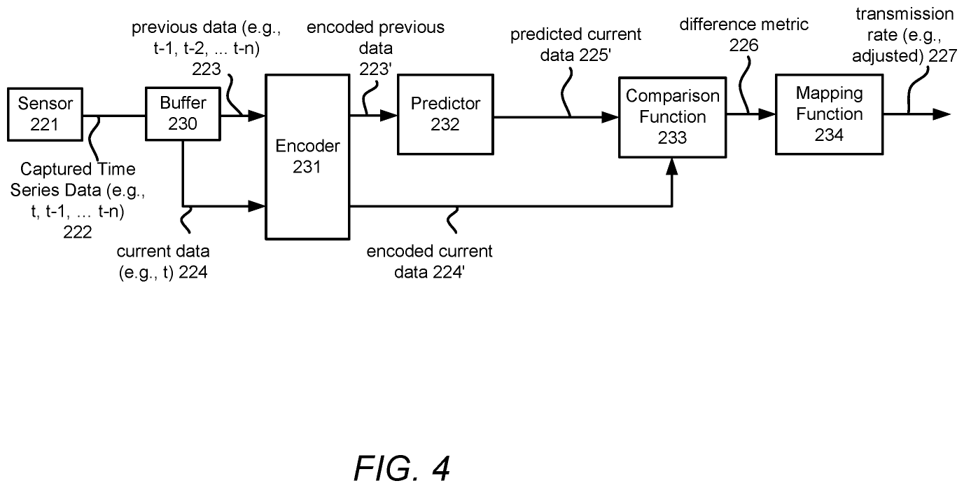

FIG. 3 shows another example of the computing device 100. The computing device 100 shown in FIG. 3 is similar to that as shown in FIG. 1 but some of the machine-readable instructions 330 are different. For example, the sensor data 222 is encoded from a higher dimensional space to a lower dimensional space before predicting the current data and comparing the predicted current data to the actual current data. FIG. 3 is described with respect to the data flow diagram shown in FIG. 4. The data flow diagram in FIG. 4 is similar to the data flow diagram shown in FIG. 2, except the data flow diagram in FIG. 4 includes encoder 231 for encoding the sensor data 222 from the higher dimensional space to the lower dimensional space before determining the predicted current data 225′ and the difference metric 226.

The machine-readable instructions 130 shown in FIG. 3 include instructions 301 to encode data, such as the sensor data 222, from the higher dimensional space to the lower dimensional space; the encoding may be performed by the encoder 231 shown in FIG. 4. The sensor data 222 exists in a dimensional space. A dimensional space is defined by the number of dimensions in the space. Each dimension in the space may refer to a unique value that represents a sensor value. For example, if the sensor data 222 is comprised of images, each pixel in the image is a dimension. For example, a 300×300 pixel image where each pixel is represented by a value between 0 and 255 has 300×300=90000 dimensions. Regardless of whether the sensor data 222 is an image, video, text, speech, or purely numeric, it commonly exists in a high dimensional space.

The encoder 231 encodes the sensor data 222 to a lower dimensional space. The encoder 231 reduces the number of dimensions by determining a subset of the dimensions less than the original that are principal dimensions. For example, for image sensor data, the encoder 231 determines a subset of the pixels in the image that are important, e.g., 1000 pixels, and uses that subset as the lower dimension vector to represent the image.

In an example, the encoder 231 is a machine learning encoder for performing dimensionality reduction. For example, the encoder is trained to learn the temporal dynamics of the sensor data 222, and to rely on features learned from the training to make more accurate assessments of the dimensions that are changing and may be of interest. For images or video or speech, the encoder 231 may be a neural network. For images or video, the encoder 231 may be trained with input images and an input parameter that specifies the number of dimensions to represent the image. For example, autoencoders are neural networks used for image or audio data that are trained to reconstruct their original inputs instead of classifying them. An autoencoder may structure a hidden layer of the neural network to have fewer neurons than the input/output layers. Thus, that hidden layer learns to produce a smaller representation of the original image, i.e., lower dimensional image. An autoencoder may be created through unsupervised learning because the input image is used as the target output.

The dimensionality reduction performed by the encoder 231 provides multiple advantages. It reduces the time and storage space required. Also, it can improve the performance of the machine learning model for the predictor 232 because the predictor 232 is focused on the dimensions that may be of interest.

The processor 102 executes instructions 302 shown in FIG. 3 to predict current data, shown as predicted current data 225′ in FIG. 4. For example, previous data 223, which may be extracted from the buffer 230, is associated with times t-1, t-2, . . . t-n. The previous data 223 is encoded by the encoder 231 to the lower dimensional space, and predicted current data 225′ is determined from the encoded previous data 223′. Also, the current data 224 associated with time t is encoded by the encoder 231 shown in FIG. 4 to the lower dimensional space.

The processor 102 executes instructions 303 to apply a comparison function to the predicted current data and encoded current data to determine a difference metric. For example, the predicted current data 225′ and the encoded current data 224′, which are in the lower dimensional space, are applied to comparison function 233 to determine the difference metric 226, similarly as is described with respect to FIGS. 1-2. The processor 102 executes instructions 304 to determine, based on the difference metric 226, whether to modify a transmission rate, similarly as is described with respect to FIGS. 1-2.

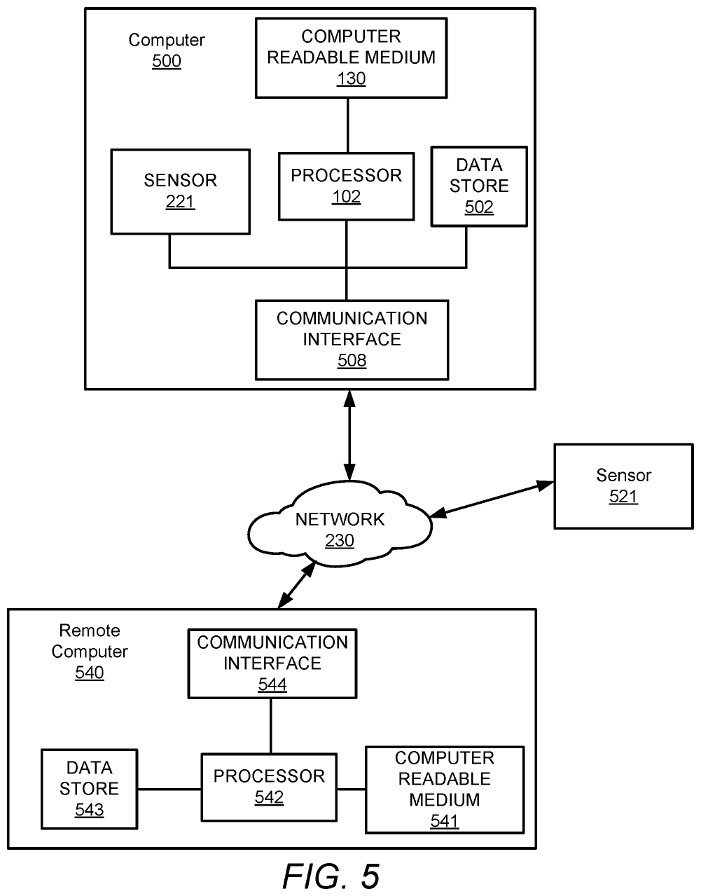

FIG. 5 shows a system diagram that depicts examples of computers that may perform the operations discussed with respect to FIGS. 1-4. In an example, determination of whether to adjust the transmission rate is performed locally, such as by a computer 500 which is connected to the sensor 221 or has the sensor 221 integrated therein. The computer 500 may embody the components shown in FIG. 1 or FIG. 3. For example, and the computer 500 includes the processor 102 and the computer readable medium 130. The processor 102 executes the machine-readable instructions 130 or 330 to perform the operations discussed above. The sensor 221 may be integrated with the computer 500 or connected to the computer 500 via an interface. The computer 500 includes a data store 502 and a communication interface 508. The data store 502 may store the sensor data 222 and any data used by the computer 500. The data store 502 may be embody the buffer 230 shown in FIGS. 2 and 4. Also, the encoder 231, the predictor 232, the comparison function 233 and/or the mapping functions 234 shown in FIGS. 2 and 4 may be embodied in machine-readable instructions executed by the processor 502. The communication interface 508 may include a network interface to communicate information via network 230. The network 230 is a communications network, such an Internet Protocol network, a telephone network, and/or a cellular network. The sensor data 222 may be communicated to remote computer 540 via the network 230. For example, the sensor data 222 is streamed to the remote computer 540. The processor 102 determines whether to adjust the transmission rate of the sensor data 222 according to the operations discussed above. The remote computer 540 may run applications to process the sensor data 222. In an IoT environment, the remote computer 540 may be connected to multiple computers and sensors to receive sensor data. For example, the sensors may be edge devices that collect and transmit their sensor data to the remote computer for further processing. For example, the sensors may be part of a security system or may be sensors in a factory that continuously collects data from the sensors and transmits the sensor data at the determined transmission rates from the sensors to the remote computer 540. The remote computer 540 analyzes the received sensor data, and performs real-time or non-real time decision-making processes based on the sensor data. The computer 500 decides whether to adjust the transmission rate of sensor data to the remote computer 540 based on the prediction, comparison and mapping operations discussed above. For example, the processor 102 in the computer 500 determines a transmission rate for transmitting the sensor data 222 to the remote computer 540, and controls the data transmission rate accordingly via the communication interface 508.

In another example, determination of whether to adjust the transmission rate is performed remotely at the remote computer 540. For example, sensor 521 captures time series sensor data, similar to the sensor data 222 discussed above, and transmits the sensor data to the remote computer 540 via the network 230. The remote computer 540 includes communication interface 544, processor 542, data store 543 and non-transitory computer readable medium 541. The remote computer 540 receives the sensor data via the network 230 and the communication interface 544, and stores the sensor data in the data store 543. The processor 542 executes machine-readable instructions, such as machine-readable instructions 130 or 330, stored in the computer readable medium 541. Also, the encoder 231, the predictor 232, the comparison function 233 and/or the mapping functions 234 shown in FIGS. 2 and 4 may be embodied in machine-readable instructions stored in the computer readable medium 541 and executed by the processor 542. The processor 542 executes the machine-readable instructions to determine whether to adjust the transmission rate at which the sensor 521 transmits the sensor data to the remote computer 540. If the processor 542 determines the transmission rate is to be adjusted, the processor 542 transmits a signal to the sensor 521 or a computer connected to the sensor 521 to adjust the transmission rate of the sensor data to a specified transmission rate. The sensor 521 or a computer transmitting the sensor data for the sensor 521 then adjusts the transmission rate accordingly. In an IoT environment, the remote computer 540 may be connected to multiple computers and sensors to receive sensor data and adjust transmission rates accordingly. Also, the remote computer 540 may run applications to process the received sensor data.

In another example, the processing of sensor data to determine whether to adjust transmission rate to the remote computer 540 may be performed locally and remotely. For example, some sensors may be integrated or connected locally to a computer that can perform the processing to determine whether to adjust transmission rate, and some sensors may not be integrated or connected locally to such a computer, so the processing to determine whether to adjust transmission rate is performed at the remote computer 540 for those sensors.

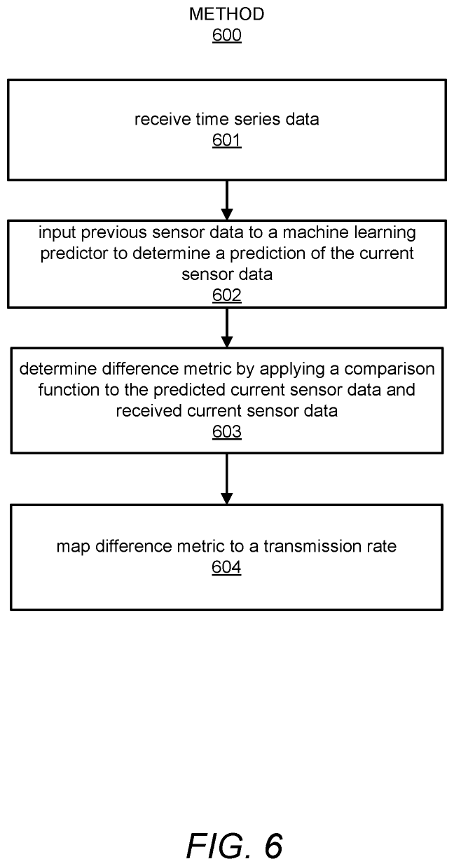

FIG. 6 shows a method 600 for determining a transmission rate, according to an example. The method 600 is a computer-implemented method that may be performed by any of the computers and processors mentioned above. Some or all of the steps of the method 600 may be included as utilities, programs, or subprograms, in any desired computer accessible medium. The method 600 is described by way of example with respect to components in FIGS. 1-5.

At 601, data, such as time series sensor data 222 captured by sensor 221, is received. For example, the sensor data 222 may be stored locally, such as in buffer 230, and received by the processor 102 to determine whether to adjust the transmission rate, or the sensor data 222 may be received at the remote computer 540, and the remoter computer 540 determines whether to adjust the transmission rate.

At 602, previous sensor data is input to a machine learning predictor, such as predictor 232, to determine a prediction of the current sensor data. For example, as shown in FIG. 2, previous data 223, is input to the predictor 232 to determine predicted current data 225. In the example shown in FIG. 4, the previous data 223 is encoded to a lower dimensional space before inputting to the predictor 232.

At 603, a difference metric is determined by applying a comparison function to the predicted current sensor data and received current sensor data. For example, as shown in FIG. 2, the difference metric 226 is determined by applying the predicted current data 225 and the current data 224 to the comparison function 233. In the example shown in FIG. 4, the difference metric 226 is determined by applying the encoded predicted current data 225′ and the encoded current data 224′ to the comparison function 233.

At 604, the difference metric is mapped to a transmission rate. For example, as shown in FIGS. 1 and 4, the difference metric 226 is mapped to a transmission rate 227 based on mapping function 234. The transmission rate determined at 604 may be different than a transmission rate currently being used. In that case, the transmission rate is adjusted to the transmission rate determined at 604. In one example, the remote computer 540 determines the adjusted transmission rate and sends a signal to the computer 500 or sensor 521 to adjust the transmission rate to the transmission rate determined at 604. In another example, computer 500 determines the transmission rate at 604 and sets the transmission rate accordingly, so the sensor data 222 is transmitted to the remote computer 540 at the transmission rate determined at 604.

Although described specifically throughout the entirety of the instant disclosure, representative examples of the present disclosure have utility over a wide range of applications, and the above discussion is not intended and should not be construed to be limiting but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. An apparatus comprising:
a processor; and
a non-transitory computer readable medium on which is stored instructions that when executed by the processor, are to cause the processor to:
receive time series data captured by a sensor, the time series data including current sensor data associated with a current time and previous sensor data associated with previous times;
input the previous sensor data to a machine learning predictor to determine a prediction of the current sensor data;
apply a comparison function to the predicted current sensor data and the received current sensor data to determine a difference metric; and
based on the difference metric, determine whether to modify a transmission rate at which the time series data is transmitted to a remote computer.

2. The apparatus of claim 1, wherein the instructions are further to cause the processor to:
output a signal instructing a device associated with the sensor to modify a transmission rate of the time series data to the remote computer in response to determining the transmission rate is to be modified.

3. The apparatus of claim 1, wherein the instructions are further to cause the processor to:
encode the received time series data from a higher dimensional space to a lower dimensional space, wherein the prediction of the current sensor data and the difference metric are determined based on the encoded time series data.

4. The apparatus of claim 3, wherein the lower dimensional space represents the received time series data using less data than the higher dimensional space.

5. The apparatus of claim 3, wherein to encode the received time series data, the instructions are further to cause the processor to:
apply the received time series data to a machine learning encoder.

6. The apparatus of claim 1, wherein the instructions are further to cause the processor to:
determine the predicted current sensor data and the received current sensor data are same or similar based on the difference metric; and
instruct a device associated with the sensor to reduce a transmission rate of the time series data to the remote computer.

7. An apparatus comprising:
a processor; and
a non-transitory computer readable medium on which is stored instructions that when executed by the processor, are to cause the processor to:
receive time series data captured over time;
encode the received time series data from a higher dimensional space to a lower dimensional space;
predict current data from the encoded time series data that is associated with earlier times than the current data;
apply a comparison function to the predicted current data and encoded current data from the encoded received time series data to determine a difference metric; and
based on the difference metric, determine whether to modify a transmission rate at which the time series data is transmitted to a remote computer.

8. The apparatus of claim 7, wherein the predicted current data is in the lower dimensional space, and to apply the comparison function, the instructions are further to cause the processor to:
apply the comparison function to the current data and the predicted current data in the lower dimensional space to determine the difference metric.

9. The apparatus of claim 7, wherein the lower dimensional space represents the received time series data using less data than the higher dimensional space.

10. The apparatus of claim 7, wherein to encode the received time series data, the instructions are further to cause the processor to:
apply the received time series data to a machine learning encoder.

11. The apparatus of claim 7, wherein to predict current data, the instructions are further to cause the processor to:
apply the encoded time series data to a machine learning prediction network.

12. The apparatus of claim 7, wherein the instructions are further to cause the processor to:
output a signal instructing a device to modify a transmission rate of the time series data to the remote computer in response to determining the transmission rate is to be modified.

13. The apparatus of claim 7, wherein the instructions are further to cause the processor to:
determine the predicted current sensor data and the received current sensor data are same or similar based on the difference metric; and
instruct a device associated with the sensor to reduce a transmission rate of the time series data to the remote computer.

14. A computer-implemented method for controlling transmission rate, the method comprising:
receiving time series data captured by a sensor, the time series data including current sensor data associated with a current time and previous sensor data associated with previous times;
inputting the previous sensor data to a machine learning predictor to determine a prediction of the current sensor data;
determining a difference metric from applying a comparison function to the predicted current sensor data and the received current sensor data; and
mapping the difference metric to a transmission rate at which the time series data is to be transmitted to a remote computer.

15. The computer-implemented method of claim 14, comprising:
encoding the time series data from a higher dimensional space to a lower dimensional space, wherein the different metric is determined based on the encoded time series data in the lower dimensional space.
